(19) United States
(12) Patent Application Publication
(10) Pub. No.: US 2004/0225483 A1
(43) Pub. Date: Nov. 11, 2004

(54) FDTD HARDWARE ACCELERATION SYSTEM

(76) Inventors: Michal OKONIEWSKI, Calgary (CA); Ryan SCHNEIDER, Calgary (CA); Laurence TURNER, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/708,319

(22) Filed: Feb. 24, 2004

Related U.S. Application Data
(60) Provisional application No. 60/319,969, filed on Feb. 24, 2003.

(51) Int. Cl. G06F 17/10

(52) U.S. Cl. 703/2

(57) ABSTRACT

A finite-difference time domain (FDTD) accelerator includes a hardware circuit such as an FPGA having a plurality of one-dimensional bit-serial FDTD cells, a memory and a memory manager.

### CROSS REFERENCE TO RELATED APPLICATIONS

This application claims the priority benefit of U.S. Provisional Application No. 60/319,969 filed on Feb. 24, 2003 entitled “FDTD Hardware Acceleration System”, the contents of which are incorporated herein by reference.

### BACKGROUND OF INVENTION

The present invention relates to a hardware accelerator for use with finite-difference time-domain algorithms.

With continuing advances in consumer-driven technologies, like cellular phones, mobile computing, high-speed electronics, fiber optics and smart antennas, there is a definite need to understand and predict the behavior of complex electromagnetic structures. The finite-difference time-domain (FDTD) method has been successfully and very widely applied to the modeling of electromagnetic phenomena [1]. FDTD simulation methods are used to aid in the design of antennas, new fiber optic technologies, high-speed circuit boards, electronics and microwave circuits. FDTD has even been used at the 50/60 Hz range to simulate power lines for health studies and other research. The algorithm is computationally intensive, involving three-dimensional simulation volumes of upwards of millions of computational cells at a time.

Multiprocessor parallel computing is a typical solution proposed to speed up FDTD methods, such as the system disclosed in U.S. Pat. No. 5,774,693. Still, simulations can run for several days on multiprocessor supercomputers. Increasing the computation speed and decreasing the run times of these simulations would bring greater productivity and new avenues of research to FDTD users.

Therefore, there is a need in the art for a system for accelerating FDTD methods.

### SUMMARY OF INVENTION

The present invention is premised on the transfer of computationally intensive FDTD algorithms from conventional sequential and multiprocessing computer environment onto custom or FPGA-based hardware. Increases in the computational speed of the algorithm is achieved within the present invention using custom hardware, integer arithmetic, and fine-grained parallelism.

A typical FDTD simulation involves taking a three-dimensional volume of interest in the physical domain and placing it within a three-dimensional mesh of finite elements (cubes), which represent the local material properties, electric fields and magnetic fields at a given location in the spatial domain. Certain relationships govern the size of the elements and the number of elements required for the simulation volume. The simulation is then surrounded by absorbing boundary conditions, which emulate an infinite physical region within the finite computational resources. The FDTD method provides explicit relations that allow us to model the behaviour of electromagnetic fields in time through successive updates.

The FDTD algorithm may be used for the design and analysis of many complex electromagnetic problems, including but not limited to: (a) radar cross-sections; (b) microwave and RF structures; (c) antennae; (d) fibre-optics and photonics; (e) connectors and packaging problems; (f) high-speed electronics; (g) specific absorption rates (SARs) in cellular telephony; and (h) interactions between electromagnetic waves and biological systems such as analysis of MRI, development of new medical devices utilizing electromagnetic waves, and cellphone radiation.

In one aspect, the invention comprises a hardware device or group of devices linked to a computer processor which device acts as a FDTD co-processor. These hardware devices are accessed by a standard software call or series of calls from the FDTD software. The link may be any system bus allowing data transfer including but not limited to the PCI bus, memory bus or video bus. In one embodiment, the hardware device is a field programmable gate array (FPGA) or a VLSI silicon circuit which handles calculation of the FDTD update equations and PML (perfectly matched layer) boundary update equations and may also include memory management of associated memory chips.

### BRIEF DESCRIPTION OF DRAWINGS

Embodiments of the invention will now be described with reference to the accompanying drawings, in which numerical references denote like parts, and in which:

FIG. 1 is a schematic of a Yee Unit Cell.

FIG. 2 is a schematic represention of a Bit-serial Adder as a (a) Block Diagram and as a (b) Logic Gate Implementation.

FIG. 3 is a schematic representation of a Bit-Serial Subtractor as a (a) Block Diagram and a (b) Logic Gate Implementation.

FIG. 4 is a schematic representation of MSHIFT as a (a) Block Diagram and a (b) Logic Gate Implementation.

FIG. 5 is a schematic representation of DSHIFT as a (a) Block Diagram and a (b) Logic Gate Implementation.

FIG. 6 is a schematic representation of a Middle Slice.

FIG. 7 is a schematic representation of a FDTD Mesh Represented as an Inductor-Capacitor Mesh.

FIG. 8 is a schematic representatin of: (a) One-Dimensional Cells; and (b) Voltage/Current Signal Flow Graph, Single Cell.

FIG. 9 is a schematic representation of a Lossless Discrete Integrator (LDI).

FIG. 10 is a schematic representation of a LDI Form of the One-Dimensional FDTD Computation.

FIG. 11 is a schematic representation of a (a) One-Dimensional, Bit-Serial FDTD Cell (32-bit System Wordlength); and (b) Structure for Capacitor and Inductor.

FIG. 12 is a block diagram illustrating an installation of a hardware device of the present invention.

FIG. 13 is a block diagram illustrating a hardware device including memory banks.

### DETAILED DESCRIPTION

The present invention provides for a hardware accelerator for FDTD algorithms. All terms not specifically defined herein have their literal or art-recognized meanings.

The FDTD Method

The FDTD technique falls under the broader heading of computational electrodynamics, of which FDTD is just one methodology. There are alternatives, discussed further in [4] and [5], which include: method of moments, finite element analysis, and the boundary element technique, amongst others. These methods may be faster or more accurate than FDTD for very specialized cases. FDTD yields accurate results for a broad range of non-specific problems and this flexibility makes it an extremely useful tool. FDTD was first described over three decades ago but has only experienced renewed usage and research in the past 8-10 years. Kane Yee first proposed this technique in 1966[6], but the computational requirements made use unfeasible. More recently, computer science has seen a large increase in computational resources, at declining costs, which has catalyzed the success of this technique. Taflove”s second FDTD textbook includes a literary survey detailing the state of the art in this field [1]. There are many commercial versions of FDTD software from various companies on the market.

A brief explanation of FDTD theory is included here to highlight the properties of the algorithm that are exploited when moving it to hardware. More detailed discussion of the FDTD theory is available in the literature [7][8]. Consider the following classic equations in electrical engineering, Maxwell's Equations:

$$\begin{matrix}∇ \times \vec{H} = \vec{J} + \frac{ⅆ}{ⅆ t} \vec{D} & ( 1 ) \\ ∇ \times \vec{E} = - \frac{ⅆ}{ⅆ t} \vec{B} & ( 2 ) \\ ∇ \cdot \vec{B} = 0 & ( 3 ) \\ ∇ \cdot \vec{D} = ρ & ( 4 ) \\ ∇ \times \vec{H} = \vec{J} + \frac{ⅆ}{ⅆ t} \vec{D} & ( 1 ) \\ ∇ \times \vec{E} = - \frac{ⅆ}{ⅆ t} \vec{B} & ( 2 ) \\ ∇ \cdot \vec{B} = 0 & ( 3 ) \\ ∇ \cdot \vec{D} = ρ & ( 4 )\end{matrix}$$

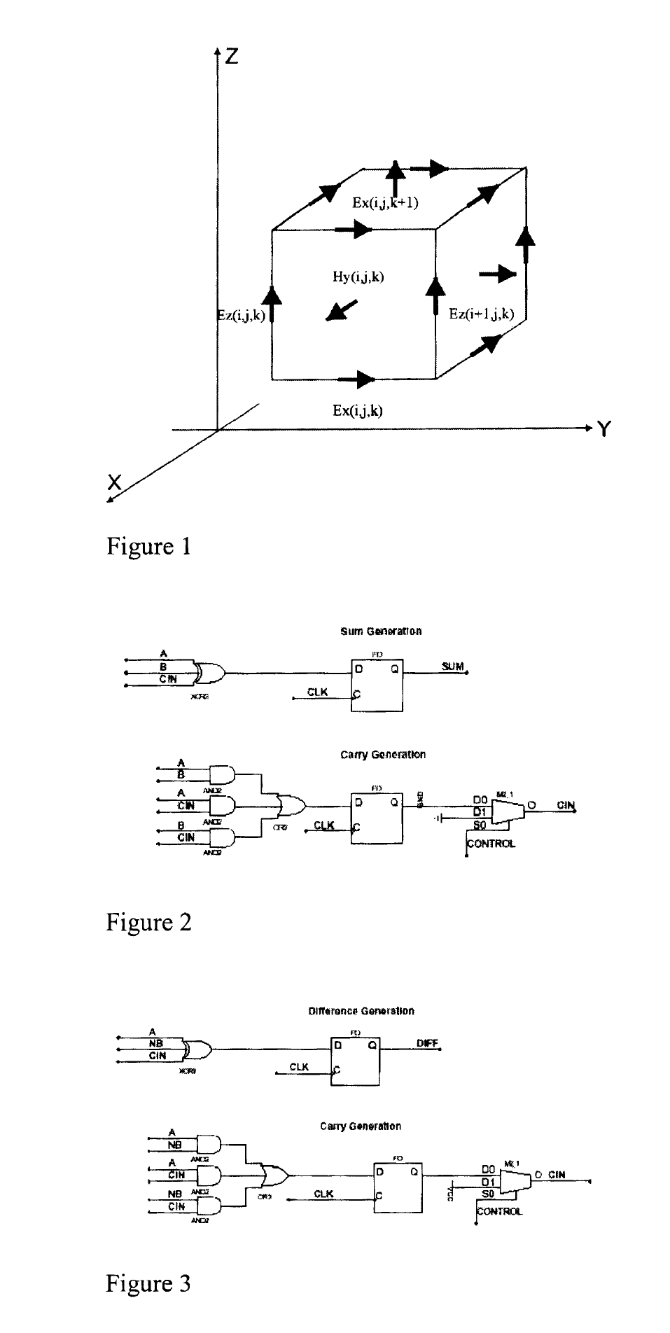

These form the basis of the theoretical equations, and their boundary conditions, which can be used to describe almost all dynamic problems in electromagnetics. Equations 1-4 represent continuous fields and continuous time, which are not well-suited to a discrete implementation. Separating the above equations into three dimensions yields six coupled equations, which describe the interaction between the electric (Er) and magnetic (Hr) fields in each plane. Yee utilized centered differences on the six coupled equations to yield discrete fields in time and space as shown in FIG. 1.

The cube is the basis of the FDTD algorithm. A large three-dimensional mesh of Yee cubes models the field distribution and electromagnetic interaction of the structure over time. Further enhancements to the FDTD algorithm allow for the specification of dielectric and magnetic properties local to each cube. A great deal of research into absorbing boundary conditions, which allow the experimenter to confine the mesh to the region of interest, has made this technique more applicable to a wider range of problems. Finally, excitations are introduced into the mesh that mimic real world applications (cellphone next to a user's head) or that best illustrate the behaviour of a region.

Similar to cellular automata, the Yee cells interact locally but the overall effect is global. The most important thing to note is that the computation of any field uses only fields from adjacent cells. The data dependency of one cell”s fields is very localized and only extends to its nearest neighbors. For example, referring to FIG. 1, the field Hy(i,j,k) is calculated using only Ez(i+1,j,k), Ez(i,j,k), Ex(i,j,k) and Ex(i,j,k+1).

The spatial increments, Δz, □y, □x define the size of the Yee cubes. They are specified such that they represent a minimum of one twentieth of a wavelength at the maximum frequency of interest. The time domain waveform is over-sampled, so that the wave velocity diagonal to the mesh approximates the speed of light. Lack of sufficient samples also affects the stability of the algorithm. Finally, the FDTD algorithm is run for at least two to four periods of the lowest frequency of interest. This allows any Ez(i,j,k) Ez(i+1,j,k) Ex(i,j,k) Ex(i,j,k+1) Hy(i,j,k) excitation to sufficiently propagate throughout the entire simulation structure.

As the mesh is refined, and the cells are reduced in size, one can see how the computational requirements increase polynomially. In fact, the relationship is roughly N³, where N is the number of cells in the mesh. As the spatial resolution is increased, the algorithm must be run for more time steps to allow for sufficient propagation throughout the mesh. There are relationships which limit the values of Δt and Δz, □y, □x which in turn bounds the cell sizes. The analysis becomes a balancing act between computational time and sampling of both time and space.

In general, t is limited by the speed of light (Cₒ) in the medium. For equal cell cube widths

$$\begin{matrix}Δ t = \frac{Δ w}{\sqrt{3} {c}_{o}} & ( 5 ) \\ Δ t = \frac{Δ w}{\sqrt{3} {c}_{o}} & ( 5 )\end{matrix}$$

This is known as the CourrantLimit. Δt cannot be increased beyond this limit, otherwise the signals are propagating from cell to cell faster than the speed of light. In practical situations, Δt is taken to be 95% or 99% of its maximum value. This prevents instability due to numerical dispersion and precision errors. The basic idea of Yee”s Algorithm, taken directly from [7], is that it centers its E and H components in time in what is termed a “leapfrog” arrangement (not unlike leapfrog ladder structures in the voltage/current domain). All of the E computations in the three dimensional space of interest are completed and stored in memory for a particular time point using H data previously stored in the computer memory. Then all the H computations in the modelled space are completed and stored in the memory using the E data just computed. The cycle can begin again with the update of the E components based on the newly obtained H. This time-stepping process is continued until the desired number of iterations is computed.

The concept of “leapfrog” computation is similar to that of leapfrog lossless discrete integrator (LDI) digital ladder filters [9]. Adapting work from [10] the FDTD structure can also be represented as a two-dimensional LDI filter structure of inductors and capacitors. This is further discussed herein below.

The observation of magnetic and electric field (H,E) values, recorded as a function of time, are the most important part of a simulation. Data collected from single points, planes or volumes, is stored and processed after the simulation. Time domain data, which makes this technique so powerful, can be used to predict performance characteristics of the modelled structure, like: return loss, insertion loss, antenna radiation patterns, impulse response and frequency response.

Table 1 below describes the number of computations required for a typical simulation.

TABLE 1
Estimated Run-Time for a Typical Simulation on an
Ideal Sequential Processor

| | | | |
|---|---|---|---|
| Typical | 100 × 100 × 100 | 1.00.E+06 | cells |
| Simulation Size | cells | | |
| | 6 | 6.00.E+06 | fields |
| | fields per cell | | |
| Typical | 10,000 | 6.00.E+10 | updates |
| | iterations | | |
| Simulation | 42 | 2.52.E+12 | flops |
| Length | flops per | | |
| | update equation | | |
| Estimated run- | 1 | 2,520 | seconds |
| time | Gigaflops per | | |
| | second processor | | |
| | | 42 | minutes |
| Typical | 100 × 100 × 100 | 1.00.E+06 | cells |
| Simulation Size | cells | | |
| | 6 | 6.00.E+06 | fields |
| | fields per cell | | |
| Typical | 10,000 | 6.00.E+10 | updates |
| | iterations | | |
| Simulation | 42 | 2.52.E+12 | flops |
| Length | flops per | | |
| | update equation | | |
| Estimated run- | 1 | 2,520 | seconds |
| time | Gigaflops per | | |
| | second processor | | |
| | | 42 | minutes |

This simple calculation does not account for variable memory access speed (cache misses, hard drive paging), operating system overhead, other processes or many of the other issues present in a traditional computer system. Also, the calculation only accounts for time spent in the core, three-dimensional field update loops. More complex simulations, incorporating recent research in the FDTD field, would perform additional computations for subcellular structures, dispersive media and absorbing boundary conditions. Accurate absorbing boundary conditions may add as many as eight layers of computational cells to each boundary of the simulation region. This can yield a 70% increase in computation time.

Simulations can run on the order of a few hours to several days on single processor PC's or multiprocessor supercomputers. It is also possible to pose problems of interest that are either too large or would take too long using existing technology.

We have found that there are a number of properties discussed above, which make this algorithm well-suited for a hardware implementation:

1. Nearest neighbor data dependence. It is theoretically possible to implement every single cube in the simulation as a separate piece of computational hardware with local connectivity. This widespread, lowlevel parallelism would yield the desired speed increase. In terms of a three-dimensional hardware implementation, only adjacent cells would need to be connected to each other but local connectivity would not exist at the routing level.

2. Leapfrog time-domain calculations. Each field update can be calculated in place and it is not necessary to store intermediate field values. Each update equation can be implemented as a multiply and accumulate structure.

3. Each field calculation, electric or magnetic, in any dimension has the same structure. This is very good for very large scale integration (VLSI) and FPGA platforms, because the repetitive structure is easy to implement.

4. Very regular structure. Except for the multiplier coefficients, which determine local electromagnetic and material properties, the computational structure is identical from simulation to simulation for a given volume. Thus, it is possible to reuse pre-compiled or partially compiled FPGA cores.

5. Material properties (ignoring dispersive media) and the sample rate remain constant throughout a simulation. Thus, coefficients remain fixed for a given field calculation for the entire simulation. This is also wellsuited to an FPGA platform. Fixed coefficient multipliers can be configured during compile time or a fixed design reconfigured at run time. Custom fixed coefficient multipliers also require less hardware than their generalized counterparts.

In one embodiment, the hardware device is the Xilinx Virtex Family FPGA, XCV300, in the PQ240 package, speed grade 4 and offers 3,072 slices. The FPGA is situated on an XESS Development board [11]. This board was chosen because it offered the latest available Virtex part at the time. The FDTD computational cells are implemented as a pipelined bit-serial arithmetic structure. Pipelined bit-serial arithmetic was chosen for the following reasons.

The hardware cost of pipelined bit-serial arithmetic units is low. Adders, subtractors and delays are reused for each bit of the system wordlength. For an N-bit system wordlength, computations take N times longer but requires 1/N times the hardware.

The size of each computational unit is small, allowing many units to be implemented in parallel for a fixed amount of hardware.

The bit-serial structure allows for very short routing lengths reducing hardware costs and simplifying routing. Integer arithmetic was chosen over floating-point arithmetic in an effort to increase computational speed and further reduce hardware costs. This is offset by the need for larger integer registers in order to maintain the dynamic range provided by a floating-point representation.

The basic building blocks including, bit-serial adders, bit-serial contractors left/right shifts, arbitrary delays, N-bit signed multipliers and the control structures are described in the following sections. Most of the following designs are taken from [12] or Denyer and Renshaw [13]. These designs are least significant bit (LSB) first.

Control signals, used for system wordlength framing, are sent to each block, to identify the arrival of the LSB at the inputs. There is also an output delay, of at least one bit time, associated with each operator, due to the pipelined nature. As the serial bitstreams pass through the operators, the data path is delayed and this also requires that the control path be delayed.

FIG. 2A illustrates a block diagram of a bit-serial adder while FIG. 2B illustrate a logic gate implementation of a bit-serial adder. The bit-serial adder can also be described as a 1-bit, carry-save adder. It does not generate the result of the addition of individual bits A and B until one clock cycle later. The carry is delayed by a clock cycle as well so that it can be applied to the following, next significant bit in the serial word. When the control/framing signal is Active High, identifying the arrival of a LSB, the carry is zeroed.

This adder occupies one Virtex slice, in particular two flip-flops and two 4-input lookup tables (LUT's). Again, the result is delayed by a clock cycle.

The bit-serial subtractor is illustrated in FIGS. 3A and 3B. For subtraction, the B-input is inverted (denoted NB) and the carry is set to be “1” when the LSB enters the block. This performs an “invert and add 1” operation so that when addition takes place the B input is subtracted from the A input. The subtractor occupies one Virtex slice, in particular two flipflops and two LUT”s.

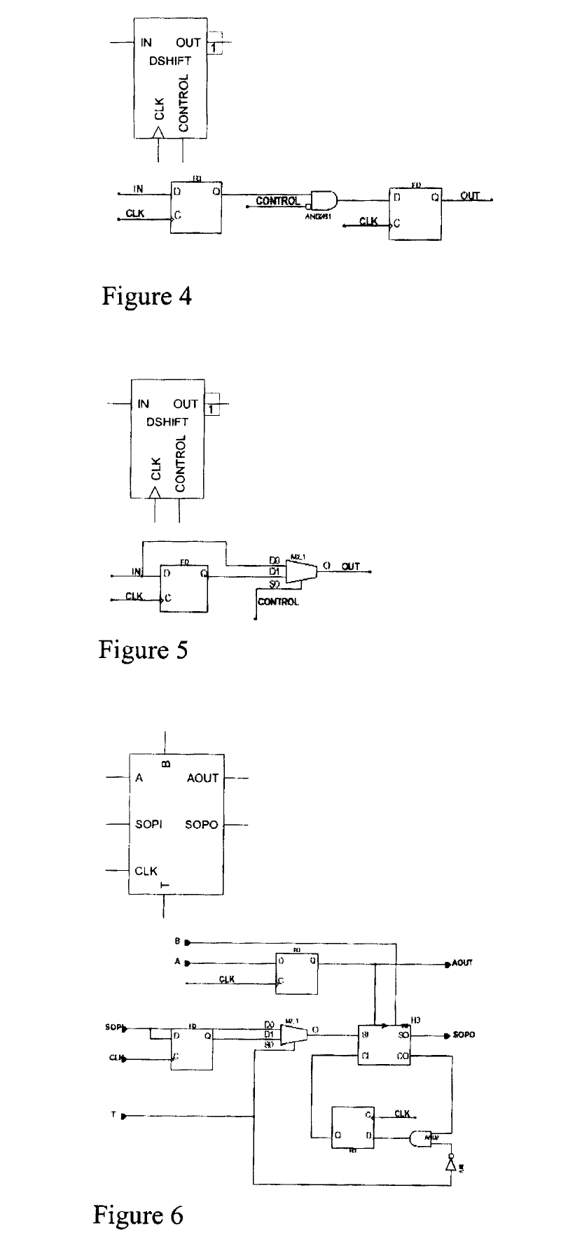

The left-shift operator illustrated in FIGS. 4A and 4B (MSHIFT [13]) performs a multiply by two on the signed serial bitstream. This block has an implied delay of one bit time, even so there are bit times of delay in the data path. This has the effect of delaying the output of the LSB by an additional clock cycle, multiplying by two. The control signal is used to insert zeros at the output when the LSB is expected. This operator occupies 1 Virtex slice, using two flip-flops and one LUT respectively.

The right-shift operator illustrated in FIGS. 5A and 5B (DSHIFT [13]) performs a divide by two on the serial bit-stream. This block has an implied delay of one bit time, even so there is no delay in the data path. The LSB arrives one clock cycle early, effectively dividing by two. The control signal is used to sign extend the data value if necessary. This operator occupies one half of a Virtex slice, using one flip-flop and one LUT respectively.

In a complex bit-serial system, the data path lengths of different bitstreams will vary when measured relative to the inputs of a given operator. In order to ensure that the LSB”s of different bitstreams arrive at the same time, it may be necessary to delay the data path. Delays from one bit time to system wordlength bits may be required. Delays larger than two to three bit times in length can be constructed efficiently using linear-feedback shiftregisters (address generation) and LUT”s (dual port RAM) [14]. The designer has control over using only flip-flops or a combination of flip-flops and LUT”s to implement delays, depending on resource availability.

In one embodiment, delays of 3 to 16 bit times occupy 2.5 Virtex slices. Delays of 17 to 32 bit times occupy 3.5 Virtex slices.

The chosen, signed-number capable multiplier implements one parallel, N-bit coefficient, and one serial multiplicand. It truncates the first N-bits of the result automatically. This multiplier may be adapted from [12]. The multiplier block consists of three main parts, each end slice and the middle slice(s) which is illustrated in FIG. 6.

The multiplicand, A, is slid past the N-bit coefficient for system wordlength clock cycles. When the LSB arrives at the input (and for N−1 additional clock cycles after this) the output of the previous word is still being generated. From FIG. 6 it can be seen that a sum of products (SOPO) is generated by a full adder (inputs: SI CI outputs: SO, CO). The sum of products is then passed to the next slice as an input. In fact, the sum of products for the entire N-bit column is computed and the resultant bit output from the block. Once again, the carry is delayed by one time unit to affect the generation of the next sum of products, and the carry is zeroed when the LSB is in the slice.

The slice associated with the most-significant bit of the coefficient is very similar to the middle slices except that the sum of products input is zeroed. There is one bit time of delay for each coefficient bit. The cost of a 12-bit multiplier is 29.5 slices, with 35 flip-flop's and 37 LUT's.

As depicted in the previous building blocks, a control signal is required when the LSB arrives. Because of the delay associated with each operand, the LSB will arrive during different cycles depending on the location in the overall circuit.

It is necessary to generate a control structure, which can output a control signal in all possible bit periods of the system wordlength. The simplest solution is to use a one-hot ring counter with the number of states equal to the system wordlength. A control structure for a system wordlength of 32-bits costs 32 Virtex slices. Table 2 summarizes the cost, in terms of Xilinx Virtex-family slices, for the various units described in the previous sections.

TABLE 2
Hardware Cost of Various Pipelined Bit-Serial
Arithmetic Units

| Arithmetic Block | Virtex Slices | Flip-flops | LUT's |
|---|---|---|---|
| Bit-Serial Adder | 1 | 2 | 2 |
| Bit-Serial Subtractor | 1 | 2 | 2 |
| Left Shift (MSHIFT) | 1 | 2 | 1 |
| Right Shift (DSHIFT) | 0.5 | 1 | 1 |
| Delay (3-16 bits) | 2.5 | 4 | 3 |
| Delay (17-32 bits) | 3.5 | 5 | 4 |
| 12-bit Multiplier (per bit) | 29.5 (2.5) | 35 (2.9) | 37 (3.1) |
| 32-bit Control Structure (per | 16 (0.5) | 32 (1) | 0 |
| bit) | | | |
| Bit-Serial Adder | 1 | 2 | 2 |
| Bit-Serial Subtractor | 1 | 2 | 2 |
| Left Shift (MSHIFT) | 1 | 2 | 1 |
| Right Shift (DSHIFT) | 0.5 | 1 | 1 |
| Delay (3-16 bits) | 2.5 | 4 | 3 |
| Delay (17-32 bits) | 3.5 | 5 | 4 |
| 12-bit Multiplier (per bit) | 29.5 (2.5) | 35 (2.9) | 37 (3.1) |
| 32-bit Control Structure (per | 16 (0.5) | 32 (1) | 0 |
| bit) | | | |

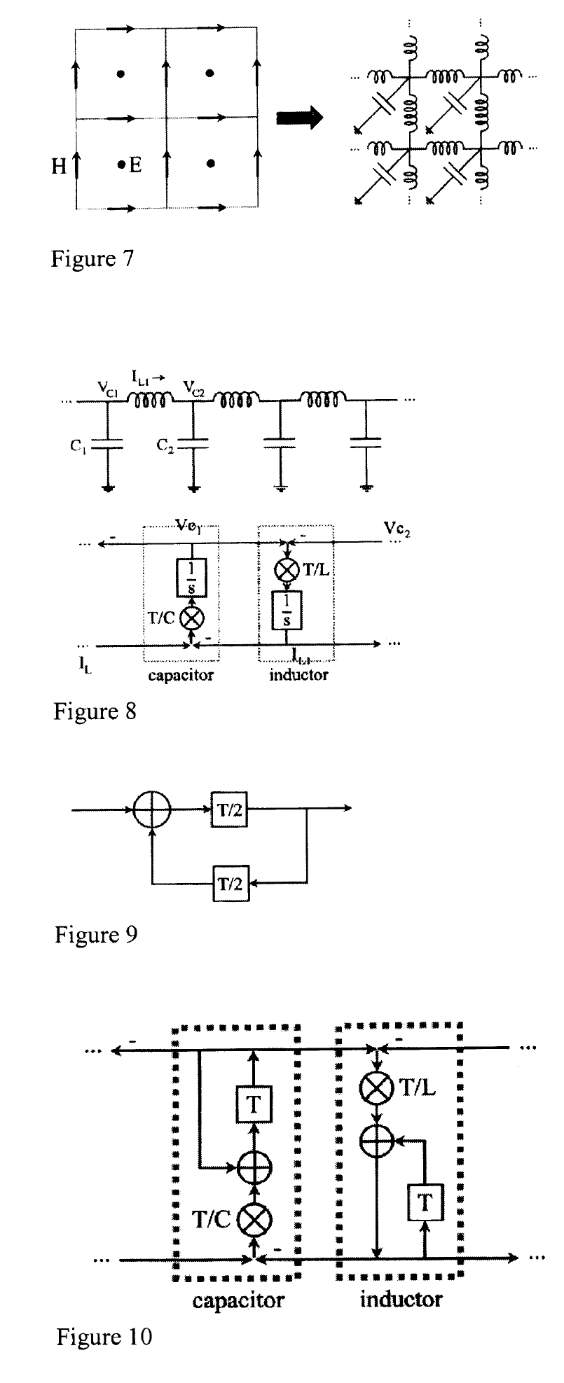

In its simplest embodiment, the invention comprises a one-dimensional implementation of the FDTD algorithm. A two-dimensional FDTD structure can be represented as a network of inductors and capacitors as shown in FIG. 7. The capacitors represent electric field storage, the inductors represent the current and consequently the magnetic field. Through impedance scaling, there are direct relationships between the inductor/capacitor values and the electromagnetic properties of the FDTD mesh. The one-dimensional FDTD case is a special case of FIG. 7, and is further explained in FIG. 8. In FIG. 8B, the “1/s” denotes Laplacian integration. The capacitor is replaced by a current-integrator likewise the inductor is replaced by a voltage-integrator. Voltages are represented by the signals along the top of the graph and currents by the signals along the bottom. Following Bruton”s work [7], the integrators are replaced by lossless discrete integrators (LDI) of the form shown in FIG. 9.

With manipulation of the delays, as for the LDI structure, the circuit illustrated in FIG. 10 is produced. It should be noted that the value of current, I, is really for time k+1. The value of voltage is at k, where is k is one-half of a simulation time step. This is the same as leapfrog LDI ladder structure and the classical FDTD algorithm.

The LDI digital ladder filter is known to have low valued transfer function sensitivity to the filter coefficient values[9]. This low sensitivity property allows high quality LDI lowpass digital filters to be constructed using very few bits to represent the filter coefficients and is also related to the very desirable low noise characteristics of the filter[15]. As the structure of the LDI lowpass digital ladder filter and the one dimensional FDTD cells are the same, this low sensitivity property may translate directly into hardware savings and low noise characteristics for the FDTD implementations. Linear stability (using ideal infinite precision arithmetic) of the FDTD structure is easily guaranteed. Furthermore, we believe that implementations using finite-precision arithmetic should also be stable.

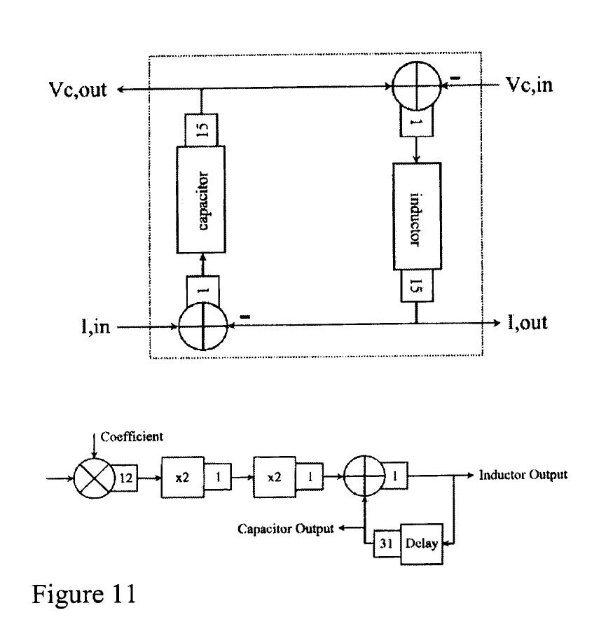

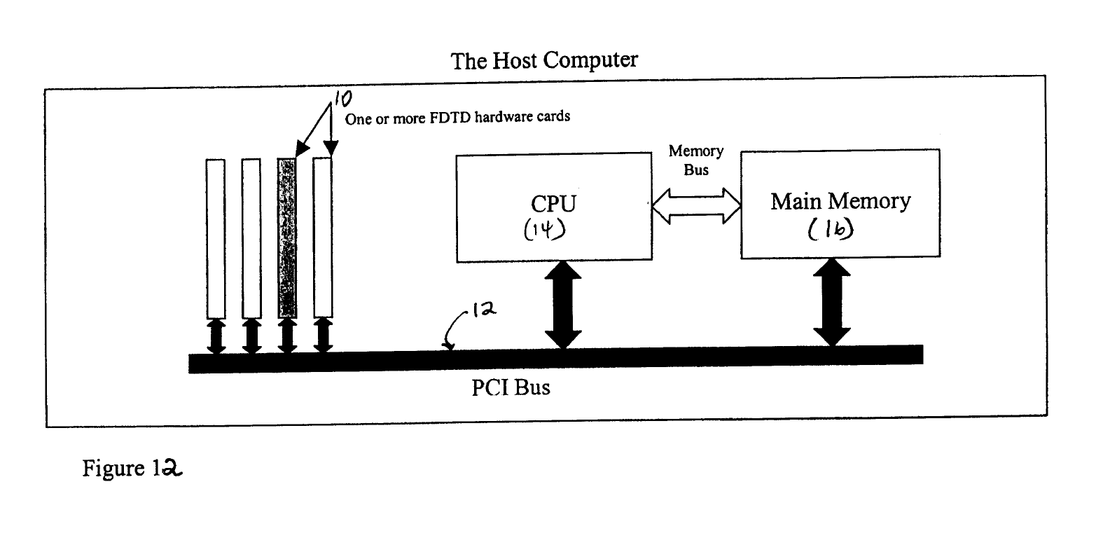

The circuit in FIG. 10 can be implemented using the pipelined bit-serial technology described in the previous sections. The resulting cell is given in FIG. 11. The design in FIG. 11 uses a system wordlength of 32-bits and 12-bit coefficients. The boxes following each block represent the delay through the block. Control signals are distributed around the circuit to mark the arrival of the LSB at each point in the loop. Each delay from FIG. 10 is 32-bits (system wordlength) long. The capacitor”s delay is distributed between its adder and the rest of the inductor/capacitor loop, requiring 31-bits of delay in the feedback path. The inductor”s delay represents the desired system wordlength delay before it is added back into the data path. The multipliers are followed by a multiply by four, which is used to change the range of coefficients (magnitude larger than one) that can be represented. Due to the symmetrical nature of the design and calculation of the two “fields”, the structures are identical. It is expected that this will not always be the case.

Additional circuitry, not shown, is used to reset the fields in the cells to zero or initialise the fields values to an excitation value.

In general, control structures are shared among a maximum of five one-dimensional, computational cells. After this, a new control structure is added. The intention is to localize the control signals and avoid the effects of clock skew.

In one embodiment, a one-dimensional resonator, terminated in perfect electric conductors (PEC”s) was generated. The PEC causes the inbound wave to be reflected back into the resonant structure and can be represented using the one-dimensional cell.

A resonator represents a trivial example, nevertheless, it is very useful for verification of the algorithmic implementation. Errors in the calculations quickly accumulate and the output becomes unbounded. The resonances are several orders of magnitude above the noise floor and narrowband. The coefficients directly relate to the location of the resonances, further verifying the multiplier structure.

The excitation is a short, time-domain impulse, intended to excite all frequencies within the resonator. The impulse is realized by biasing one of the capacitors with a non-zero value at the start of the simulation. Due to the electromagnetic behavior, the spacial location of the impulse will also affect which resonant frequencies appear in the structure and their strength.

Coefficients were chosen such that Δx=1.0 cm and μr=ar=1.0 (related to the inductor and capacitor values, respectively), which signifies free space. By experiment, it was found that 8-bit coefficients did not result in bounded-input, bounded-output (BIBO) stability. Increasing the coefficient accuracy to 12-bits provides stability.

Using 10 cells, this yields a resonator 10.0 cm in length. At least 10-20 samples per wavelength is considered the minimum. As a result, the fundamental resonant frequency would be sampled accurately but the second harmonic would be under-sampled. In testing, this resonator successfully predicted the first two resonant frequencies to within 0.65% and 1% of theoretical values. These results are identical to the results produced using a traditional FDTD simulation programmed in C++, using 32-bit floating-point numbers, on an Intel-Linux computer.

In one embodiment, the device may be run with a bit-clock maximum of 37.7 MHz, as reported by the Xilinx tools. A new result is available every system wordlength clock cycles or 849 ns (f=1.18 MHz). Each computational cell, in one-dimension, costs 86.5 Virtex slices. The resonator, 10 cells in length, used 30% of the device or 917 slices. 52 slices are used to gather the data from the simulation, yielding 865 slices for the computation and control structure.

As mentioned earlier, the pipelined bit-serial structure yields very short routing lengths. The average connection delay is 1.771 ns and average delay for the worst 10 nets was 4.208 ns.

The one-dimensional cell represents two-fields. A two-dimensional cell represents three fields. Therefore, two-dimensional cells cost 131 slices, with the addition of two more subtractors to combine four fields into the calculation of some fields. A three-dimensional cell would cost 265 slices, representing 6 fields.

The presented designs are a successful implementation of the FDTD algorithm on hardware. All one-dimensional simulations use exactly the same computational cell, except that the coefficients change to represent the underlying material properties, temporal and spacial sampling. This is true for both two and three dimensions as well, neglecting dispersive media. Therefore, designs may be created, which are compiled once and used several times. Fixed coefficients would need to be modified either at compile-time or runtime to represent a different simulation. Also, a fixed simulation structure may be re-run for a multitude of observations and excitations. Observation and excitation locations could be reconfigured at the start of the simulation without changing the rest of the structure.

The computational speed is extremely fast and is not related to the number of computational cells in the simulation. This approach represents the maximum possible level of parallelism, because every single simulation cell is implemented in hardware. Larger simulations, with more cells, simply require more hardware. As mentioned earlier, the upper limit for a typical simulation is 100,000 time steps. Assuming that the data could be exchanged between the FPGA and an external system fast enough, the entire computation would be completed in 84.9 milliseconds. While the computation time of the traditional sequential algorithm increases at roughly N³, this implementation's runtime remains constant. Thus, with a large number of hardware slices, any simulation of 100,000 time steps would take 84.9 ms.

A 10×10×10 simulation could fit on five of Virtex-2 10000 FPGAs which offer 61,440 cells each. A 100×100×100 simulation would require one million cells.

In one embodiment, a single update equation could be implemented on hardware, similar to a CISC (complex instruction set computing) instruction, that would take one “flop” or be pipelined to appear to take one “flop”. Consider a typical simulation of 100×100×100 cells, resulting in one million three-dimensional cells. Each cell contains 6 fields and 2 coefficients per field. This results in 18 values per computational cell that would need to be “loaded” for the update equation instruction. As well, the 6 field values would need to be “stored” for the next iteration. There would be approximately 96 MB (24 million values at 32-bits) of data that would need to be transacted in order to compute one iteration of FDTD.

The following calculations assume that there would be no overhead associated with the particular data bus and that the hardware would have exclusive use of this resource. The following table depicts the theoretical run-time for transferring 96 MB of data per iteration for 10,000 iterations.

TABLE 3
Comparison of Theoretical Computation Times vs.
Data Bandwidth

| | | | Computation | |
|---|---|---|---|---|
| Bus | Data Rate | | Time | |
| PCI (32-bit) | 132 | MB/s | 2 | hours |
| PC133 (133 MHz FSB) | 1.06 | GB/s | 15 | minutes |
| DDR (266 MHz FSB) | 2.12 | GB/s | 7.5 | minutes |
| PCI (32-bit) | 132 | MB/s | 2 | hours |
| PC133 (133 MHz FSB) | 1.06 | GB/s | 15 | minutes |
| DDR (266 MHz FSB) | 2.12 | GB/s | 7.5 | minutes |

If the simulation contains fixed material properties for the entire simulation, the 12 coefficients associated with each field could be cached in another storage location attached to the hardware via one or more additional memory buses. This would cut the data transfer requirements from 24 values to 12 values per cell. With DDR memory, it might be possible to complete the proposed simulation in four minutes. This would represent an order of magnitude speed increase over the benchmark prediction of 42 minutes.

Therefore, as shown schematically in FIG. 12, a hardware device (10) of the present invention may be installed on a PCI bus (12), or another data bus, of a host computer having a CPU (14) and a memory (16) which is operating FDTD software. The FDTD software has a patch or module which accesses the hardware device by a standard software call or series of calls. The hardware device, incorporating the circuits described herein, runs the FDTD update equations and the PML (perfectly matched layer) boundary condition update equations, thereby lessening the computational load on the main CPU (14).

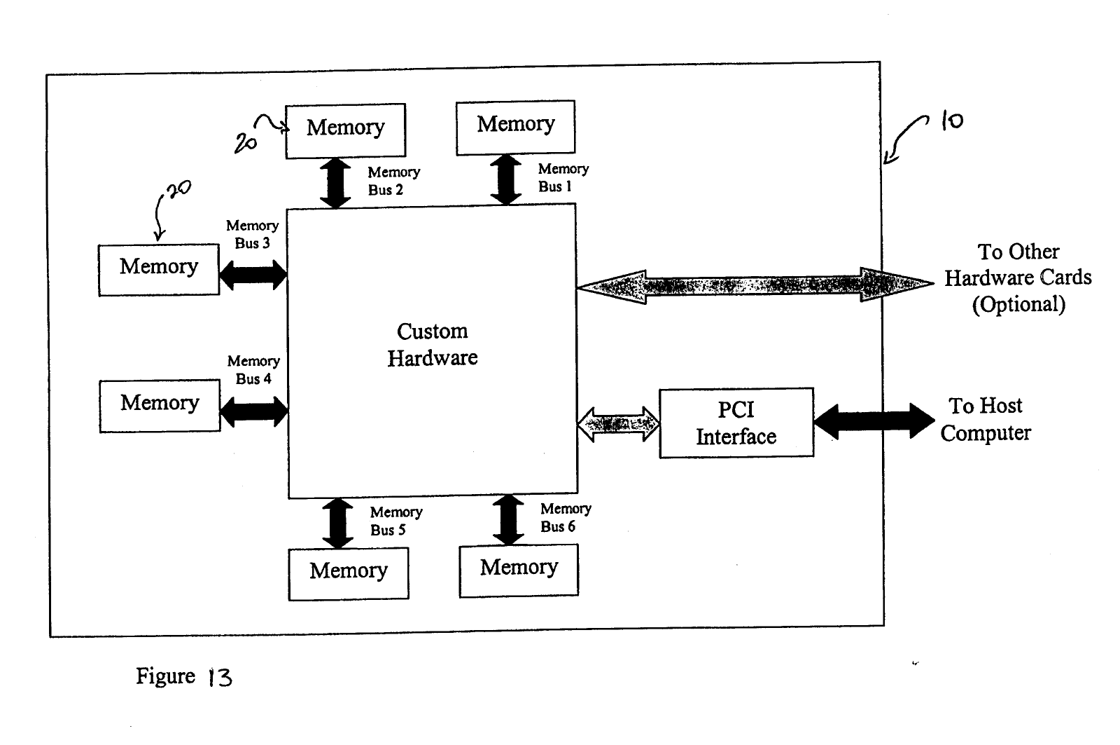

In a preferred embodiment, shown schematically in FIG. 13, the hardware device (10) includes at least one bank of memory (20) and preferably several banks of memory (20), which may be DDR SDRAM memory. The hardware circuits may then incorporate memory management functions as well as calculation of the FDTD and PML update equations and data exchange with the host CPU.

It will be readily seen by those skilled in the art that various modifications of the present invention may be devised without departing from the essential concept of the invention, and all such modifications and adaptations are expressly intended to be included in the scope of the claims appended hereto.

### REFERENCES

The following references are incorporated herein by reference as if reproduced herein in their entirety.

[1] Taflove, Allen. Advances in Computational Electrodynamics The Finite Difference Time Domain Method. Norwood, Mass.: Artech House Inc., 1998.

[2] Marek, J. R., Mehalic, M. A. and Terzuoli, A. J. “A Dedicated VLSI Architecture for Finite-Difference Time Domain Calculations” 8th Annual Review of Progress in Applied Computational Electromagnetics, Monterey, Calif., vol. 1, pp. 546-553, March, 1992.

[3] Grinin, S. V. “Integer-Arithmetic FDTD Codes for Computer Simulation of Internal, Near and Far Electromagnetic Fields Scattered by Three-Dimensional Conductive Complicated Form Bodies”, Computer Physics Communications, vol. 102, no. 1-3, pp.109-131, May, 1997.

[4] Mittra R. and Werner D. H. Frontiers in Electromagnetics. IEEE Press, 1999.

[5] Mittra R., Peterson, A. F. and Ray S. L. Computational Methods for Electromagnetics. IEEE Press, 1997.

[6] Yee, K. S., “Numerical Solution of initial boundary value problems solving Maxwell”s equations in isotropic media,” IEEE Trans. Antennas and Propagation, Vol. 14, 1966, pp.302-307.

[7] Taflove, Allen. Computational Electrodynamics The Finite Difference Time-Domain Method. Norwood, Mass.: Artech House Inc., 1996.

[8] Okoniewski, M., “Advances in FDTD Modeling: EMC and Numerical Dosimetry”, Tutorial Slides, Zurich, 1999.

[9] Bruton, L. T. “Low sensitivity digital ladder filters,” IEEE. Trans. Circuits Syst., vol CAS-22, pp.168-176, March 1975.

[10] Gwarek, W. K. “Analysis of Arbitrarily Shaped Two-Dimensional Microwave Circuits by Finite-Difference Time-Domain Method,” IEEE Trans. Microwave Theory and Techniques, vol. 36, no. 4, pp.738-744.

[11] XESS Development Corp. http://www.xess.com

[12] Hartley, R. I. and Parhi, K. K. Digit-Serial Computation. Norwell, Mass.: Kluwer Academic Publishers, 1995.

[13] Denyer, P. B. and Renshaw, D. VLSI Signal Processing A Bit-Serial Approach. Reading, Mass.: Addison-Wesley, 1985.

[14] Alfke, P. “Efficient Shift Registers, LSFR Counters and Long Pseudo-Random Sequence Generators,” Xilinx Application Note: XAPPP 052, Jul. 7, 1996., http://www.xilinx.com.

[15] Fettweis, A. “On the connection between multiplier wordlength and roundoff noise in digital filters”, IEEE Trans. on Circuit Theory, vol-19, no. 5, pp. 486-491, September 1972.

1. An FDTD acceleration system for use with a host computer operating FDTD software, comprising:
(a) a circuit comprising a plurality of one-dimensional bit-serial FDTD cells;
(b) means for interfacing with a host computer data bus; and
(c) means for accepting software calls from the host computer.

2. An FDTD acceleration system for use with a host computer operating FDTD software comprising:
(a) hardware circuit means for calculating FDTD and PML update equations;
(b) means for interfacing with a host computer data bus; and
(c) means for accepting software calls from the host computer.

3. The system of claim 2 further comprising a memory and a memory manager for temporarily storing data for use by the hardware circuit means.

4. A method of accelerating an FDTD simulation comprising the steps of:
(a) offloading FDTD update equation to a hardware circuit comprising a plurality of one-dimensional bit-serial FDTD cells;
(b) accepting the updated values from the hardware circuit; and

5. The method of claim 4 comprising the further step of temporarily storing updated equation data in a memory operatively connected to the hardware circuit.
